(19) United States
(12) Patent Application Publication
(10) Pub. No.: US 2011/0177298 A1
(43) Pub. Date: Jul. 21, 2011

(54) CORRUGATOR

(75) Inventor: Richard Gardiner, Herefordshire (GB)

(73) Assignees: RICHARD GARDINER, Herefordshire (GB); RKVO TRUST, Herefordshire (GB)

(21) Appl. No.: 12/672,884

(22) PCT Filed: Aug. 6, 2008
(86) PCT No.: PCT/GB2008/002672

§ 371 Date: May 21, 2010

(30) Foreign Application Priority Data
Aug. 10, 2007 (GB) 0715679.7

(51) Int. Cl. B32B 29/08; B32B 37/02; B32B 37/12; B32B 37/14; B32B 38/00; B32B 3/12

(52) U.S. Cl. 428/178; 156/443

(57) ABSTRACT

A corrugator comprising a curved base element (14) rotatable around an axis of rotation; and a flat base element (12) translatable relative to said axis of rotation, said base elements (12, 14) having a plurality of corresponding corrugation formers (24) such that a flexible material (26) may be fed between said base elements (12, 14), the corresponding corrugation formers (24) interdigitating such that said flexible (material 26) is folded at a non-elevated temperature by the co-operation of the corrugation formers (24) so as to create creased corrugations (25) in the flexible material (24).

This invention relates to a corrugating machine also known as a corrugator.

Known corrugating machines for forming corrugated board have intermeshing rollers. The outer surfaces of the rollers are integrally formed with elongate grooves and ridges which extend the length of the roller in parallel with its rotational axis. Since the rollers are positioned so that the grooves of one roller can intermesh with the ridges of the other roller, when a sheet of flexible material, such as paper or card, is fed therebetween, transversely extending corrugations, also known as flutes, are formed along its length.

Whilst the sheet of flexible material is fed between said rollers, high pressures and temperatures, typically around 163 degrees Celsius, are used in combination with steam to press continuously arcuate, wave-like or sinusoidal shaped corrugations into said sheet of flexible material. The fibres of the flexible material are thus pressed or deformed into the corrugated shape. However, the combination of heat, pressure and steam makes the process not only complex and of high energy and financial cost, but also relatively hazardous to those operating the machinery.

The pressing process used in known conventional corrugating machines cannot be used with certain types of flexible material, for example, paper with a long fibre length. Such materials may have a greater strength than that of the materials currently used within the corrugation process and as such the strength of the corrugated material is limited by said pressing process.

Conventional corrugating machines construct corrugated board by gluing liners to the ridges of both sides of the corrugated material. Hot starch glue is applied along the entire length of each ridge, the liners then being pressed onto the corrugated material under heating so as to cure the glue. As before, the use of heat results in an expensive process with a high-energy requirement. Also, applying glue along the entire length of each ridge is both environmentally and financially wasteful.

The continuously curving surface of the corrugations in said flexible material, which forms part of the corrugated board, has two main limitations due to its wave-like or sinusoidal profile:

First, corrugations of this type tend to be relatively weak under compression in a direction parallel to the height of the corrugations (this is also known in the field as the ‘crush strength’).

Secondly, compared to, for example, discrete folds, the continuously curving surface of the corrugations take up more space transversely to the corrugation profile or lateral extent of the corrugation. As such, it is possible to only fit a certain number of continuously arcuate corrugations into a given length of flexible material. This contributes to a reduction in crush strength as well as a reduction in the strength of the corrugated board in a direction parallel to the longitudinal extent of the ridges (this is also known in the field as the ‘spine strength’). Also, due to the inevitably greater spacing between ridges of continuously curved corrugations, a poorly finished flat liner surface which is both less attractive and more difficult to print on, can result.

The present invention seeks to overcome these problems.

According to a first aspect of the present invention, there is provided a corrugator comprising a curved base element rotatable around an axis of rotation; and a flat base element translatable relative to said axis of rotation, said base elements having a plurality of corresponding corrugation formers such that a flexible material may be fed between said base elements, the corresponding corrugation formers interdigitating such that discrete folds are imparted at a non-elevated temperature to said flexible material by the co-operation of the corrugation formers so as to create creased corrugations in the flexible material. Relating to the current invention, the term interdigitating is defined as where two components (in this case the corresponding corrugation formers of the curved and flat base element) interweave or interlock in a repetitive alternating adjacent manner, similar in nature to that which occurs when one crosses one's fingers.

Desirably, said curved base element is generally cylindrical. This results in the base element having a constant radius as it is rotated and as such the flat base element can be located at a constant distance from said rotation axis as it translates and hence reduces the complexity of movement of the corrugator.

Preferably, said flat base element comprises a plurality of similar flat members joined to one another in an end to end manner by at least one linkage such that the flat portions form a continuous conveyor. This enables the corrugation process to be continuous.

Advantageously, the corrugator further comprises vacuum means for retaining said flexible material on the corrugation formers of the flat base element. This enables the flat base element to retain the flexible material subsequent to corrugation.

Desirably, said corrugating formers are operable at room temperature to form corrugations in the flexible material. This will result in reduced operating costs compared to a higher temperature process.

Preferably, the corrugating formers are positioned and shaped such that the profile of the corrugations created in said flexible material comprises at, least two straight sides. The straight sides result in an increase in crush strength of corrugated board formed from the corrugated material.

Advantageously, the corrugating formers are positioned and shaped such that the profile of the corrugations created in said flexible material is substantially an isosceles triangle with its base removed comprising folded or creased radiused apex portion intermediate two straight or flat side portions at an acute angle to one another.

Desirably, said acute angle is in the range of 60 to 64 degrees. Preferably, the range is 60 to 61.5 degrees. However, more preferably, the angle is 61.1 degrees. Such an angle, or range of angles, not only increases the crush strength of corrugated board formed from the corrugated material, but also increases the strength of such a board by enabling a greater concentration or number of corrugations in said flexible material per unit distance, generally increasing the number of corrugations by 25% per unit linear distance, allowing each base element to have at least five corrugation formers per linear inch (25.4 millimetres).

Preferably, the corrugator additionally comprises liner means for affixing a liner to each of the corrugations on a first side of said flexible material following corrugation. This enables the creation of single face corrugated board.

Desirably, the liner means includes a room temperature bonding agent. Such a bonding agent is relatively easy and cheap to cure.

According to a second aspect of the invention there is provided a corrugator comprising corrugating apparatus which provides corrugations in a sheet of flexible material; a rotatable adhesive cylinder downstream of the corrugating apparatus; an adhesive tank; supply means for supplying adhesive stored in the adhesive tank to an outer surface of said adhesive cylinder; and a feeder mechanism by which the corrugated sheet of flexible material is fed to said adhesive cylinder, the adhesive being transferred at a non-elevated temperature from said in use adhesive cylinder to a portion of each of the corrugations on a first side of said corrugated material.

Desirably, adhesive is fed to said adhesive cylinder such that the adhesive cylinder applies a portion of adhesive to a plurality of discrete portions of each corrugation on said first side of said corrugated material. This leads to a reduction in the volume of adhesive used per corrugation and hence a reduction in cost. It also reduces warping of both the corrugated and liner material.

Advantageously, the supply means comprise a metering element for metering adhesive on to the adhesive cylinder.

Preferably, said metering element comprises a metering blade adjacent to said adhesive cylinder, adhesive being supplied from said adhesive tank to the metering blade, the in use metering blade applying a constant or substantially constant volume of adhesive to said adhesive cylinder in any given time period.

Desirably, said metering blade comprises at least one channel for allowing the flow of adhesive to said adhesive cylinder.

Advantageously, the pitch of a plurality of channels determines the volume of adhesive which is transferred from said adhesive cylinder to said portion of each of the corrugations.

Desirably, replacing said metering blade allows the pitch of said plurality of channels to be changed.

Preferably, the lateral dimension of the at least one channel is devised so as to apply a particular discrete volume of adhesive to each corrugation.

Advantageously, said metering blade comprises an edge which removes excess adhesive from the adhesive cylinder. This reduces wastage of adhesive.

Preferably, the corrugator additionally comprises liner means for affixing a liner to each of the corrugations on a first side of said flexible material following corrugation. This enables the creation of single face corrugated board.

Desirably, the liner means includes a room temperature bonding agent. Such a bonding agent is relatively easy and cheap to cure.

The present invention will now be described, by way of example, with reference to the accompanying drawings, wherein:

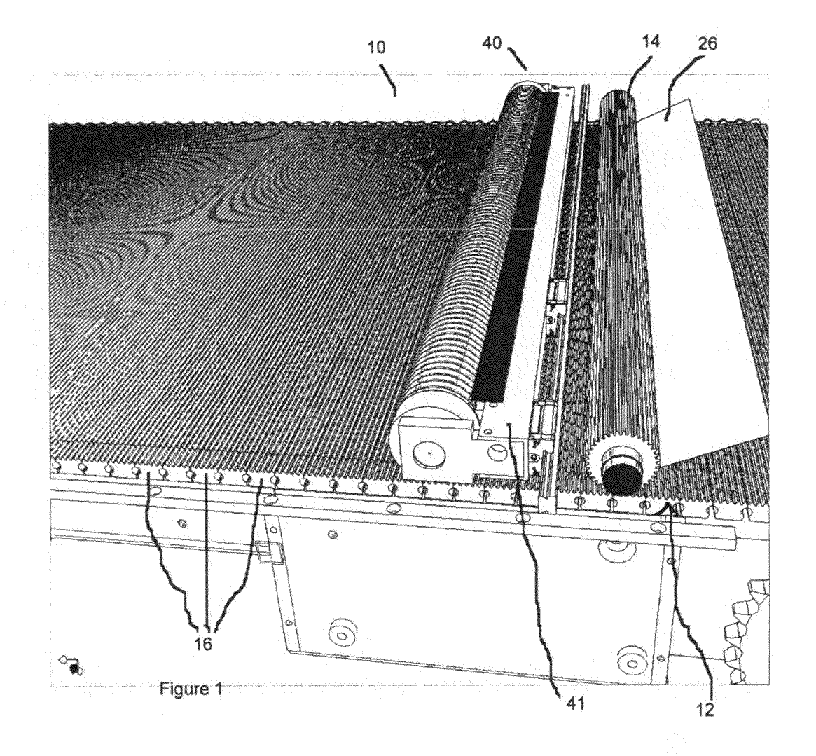

FIG. 1 is a diagrammatic perspective view of a part of one embodiment of an in use corrugator, in accordance with the first and second aspects of the present invention, showing corrugator apparatus and an adhesive cylinder;

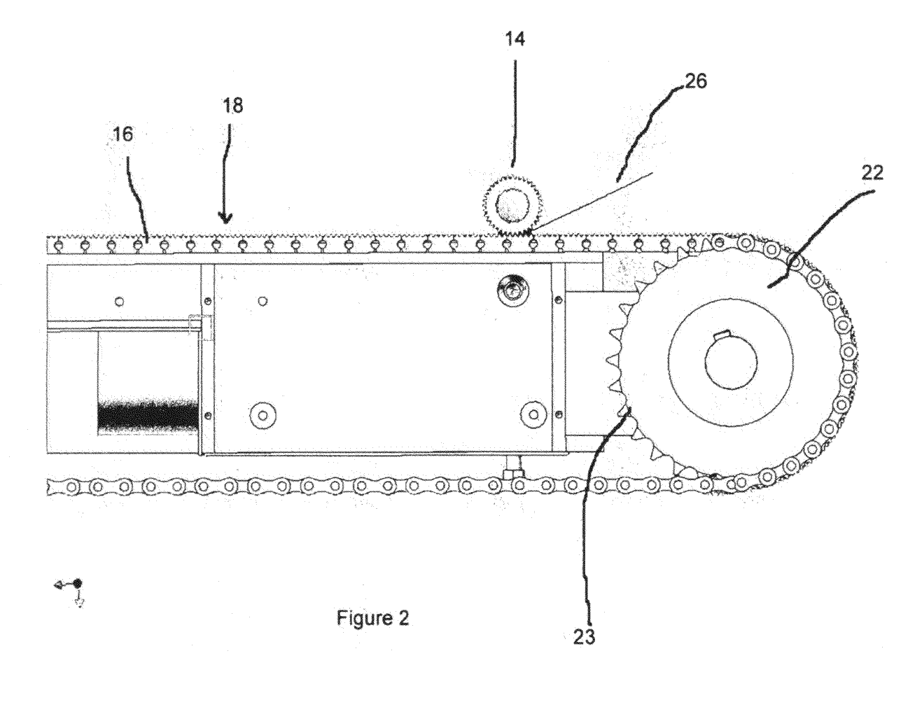

FIG. 2 is a diagrammatic side elevation of a portion of the corrugator shown in FIG. 1, with the adhesive cylinder removed for clarity;

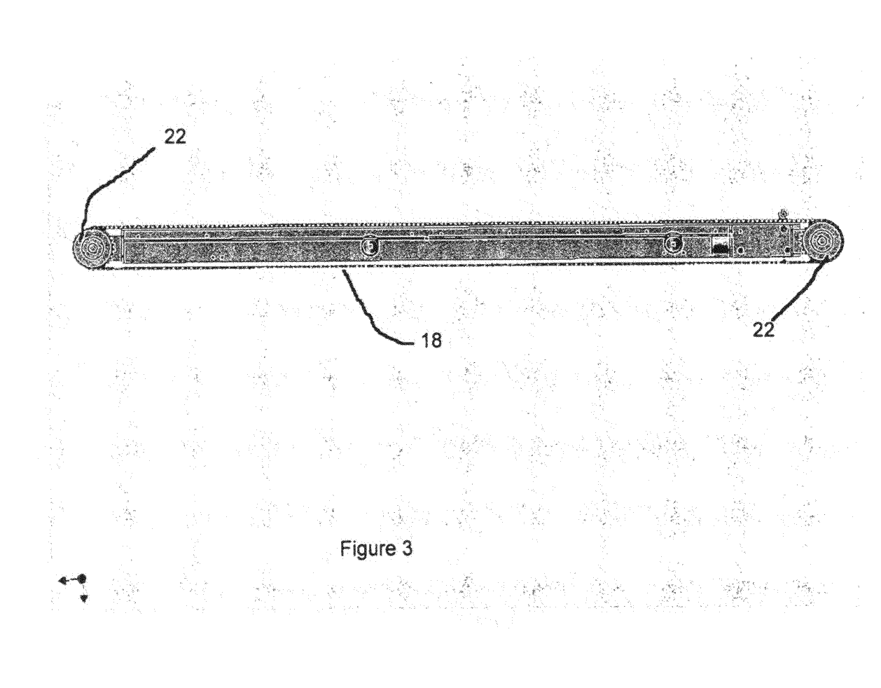

FIG. 3 is a diagrammatic side elevation of the corrugator shown in FIG. 1, again with the adhesive cylinder removed for clarity;

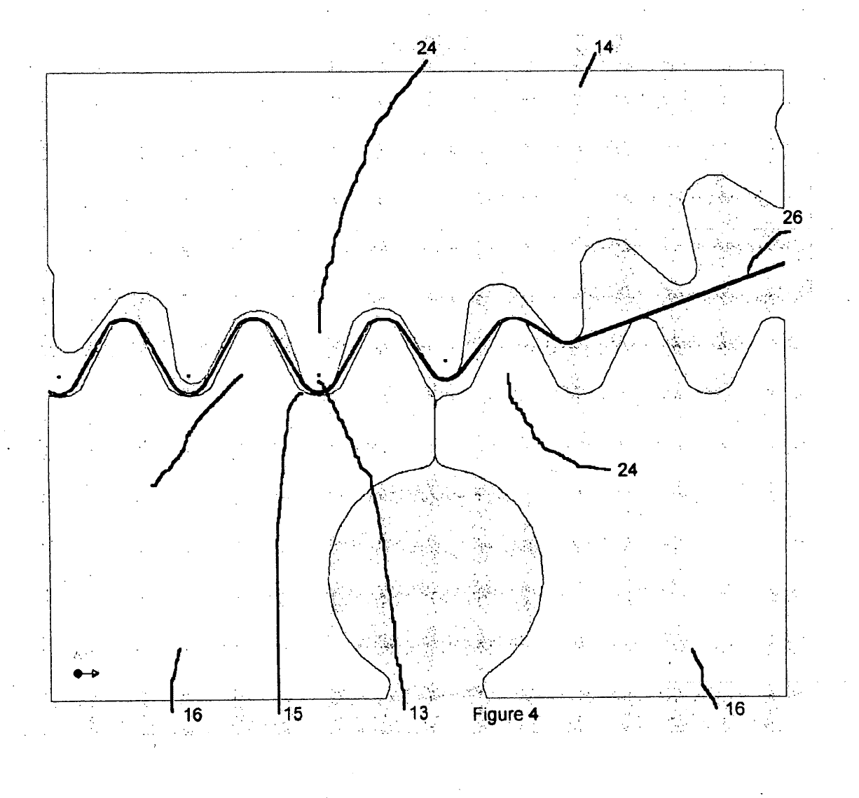

FIG. 4 is an enlarged view of part of FIG. 2 showing interdigitating corrugation members;

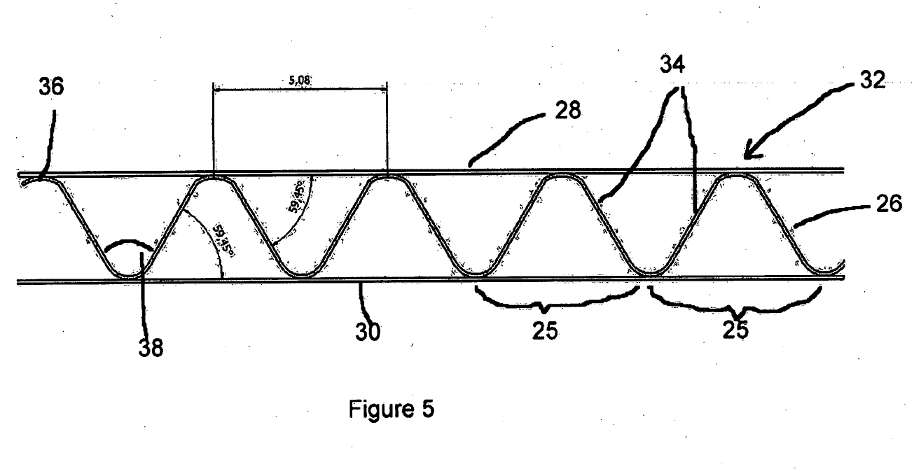

FIG. 5 is an enlarged cross-section of a portion of corrugated board comprising material corrugated by the corrugator shown in FIG. 1;

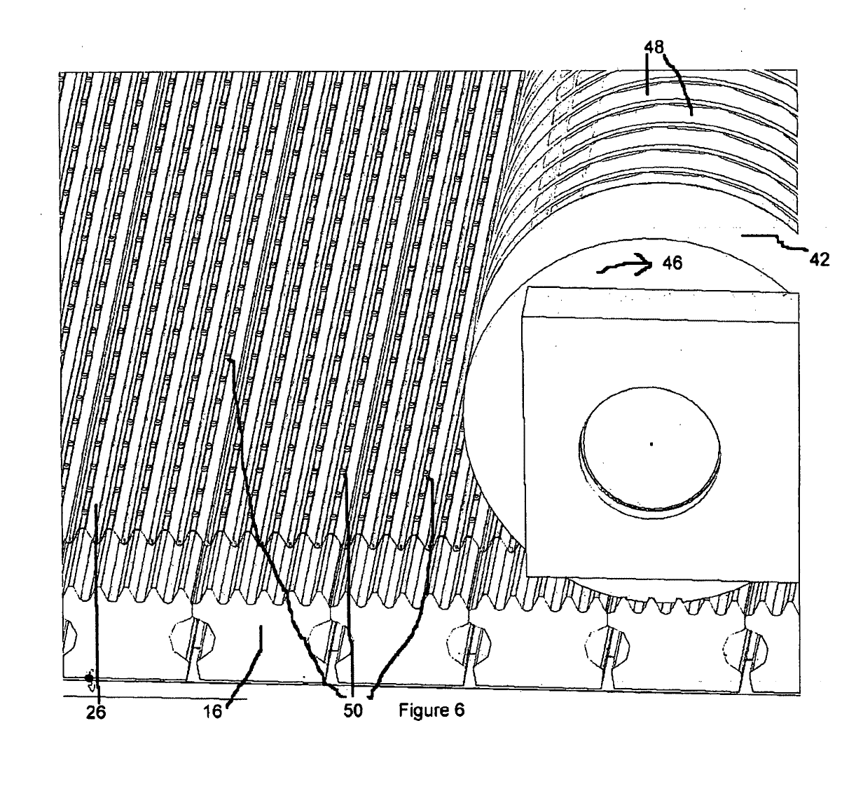

FIG. 6 is an enlargement of a part of FIG. 1 showing the adhesive cylinder in greater detail;

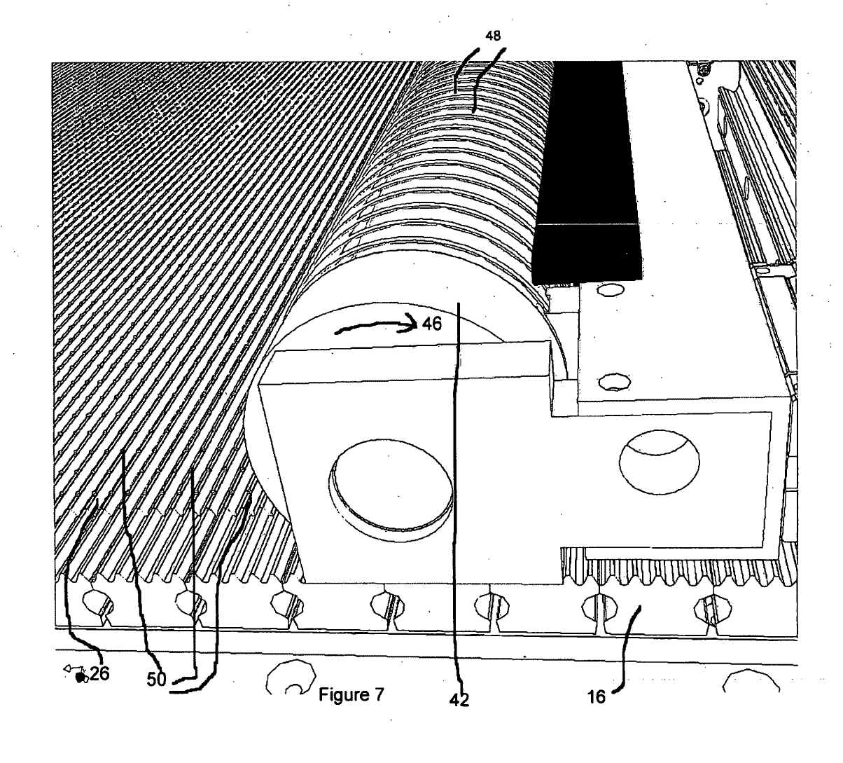

FIG. 7 is a view similar to FIG. 6, showing the adhesive cylinder and adhesive tank;

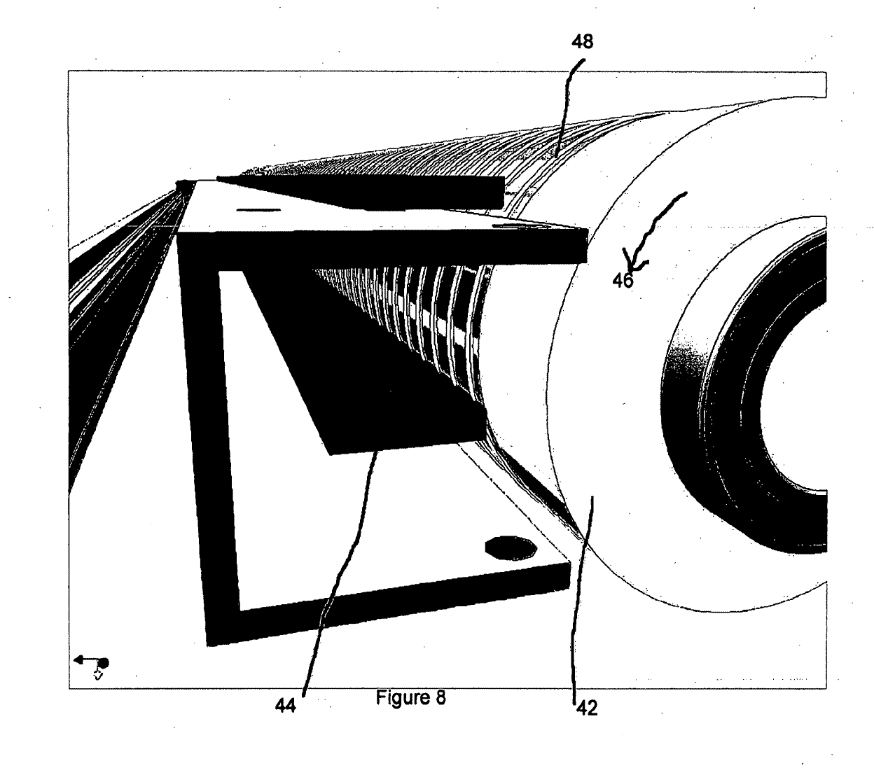

FIG. 8 is an enlarged diagrammatic perspective view of a part of the corrugator shown in FIG. 1, showing the adhesive cylinder and a metering blade in greater detail; and

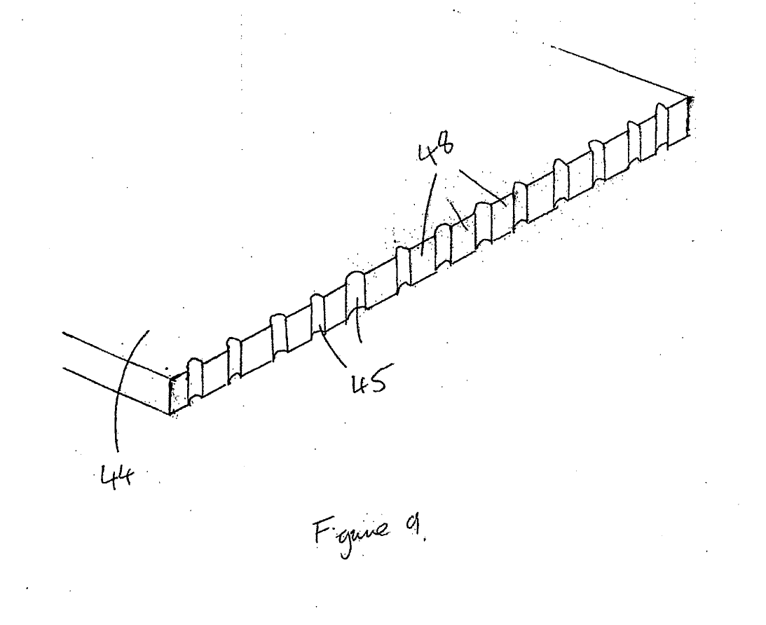

FIG. 9 is a diagrammatic perspective view of part of the metering blade shown in FIG. 8.

As seen best in FIG. 1 the corrugator, indicated generally as 10, comprises a generally flat base element 12 and a generally cylindrical base element 14 adjacent the flat base element 12. The flat base element 12 comprises a plurality of similar generally flat base members or plates 16 which are linked together so as to form a continuous conveyor 18 which pivots around end sprockets 20, 22. In order to provide a mechanical link between the conveyor 18 and sprockets 20, 22 the sprockets 20, 22 may be provided with teeth 23 which are received within corresponding recesses (not shown) on the underside of each base plate 16.

The cylindrical base element 14 is rotatably held in a fixed position relative to the conveyor 18, for example by a fixed support element (not shown).

Both of the base elements 12, 14 have a plurality of corresponding generally v-shaped lateral cross-section corrugation formers 24 which extend parallel to the axis of rotation of the cylindrical base element 14. The formers 24 are sized and positioned such that, as best seen in FIG. 4, as the base element 14 is rotated the corresponding formers 24 on each base element 12, 14 interdigitate, with the peak 13 of the former 24 of one base element 14 being received within a trough 15 of the corresponding former of the other base element 12 and vice-versa, hence driving the flat base element 12 (and consequently the conveyor 18) in a linear manner at a tangent to the rotational motion of the curved base element 14. Likewise, if the conveyor 18 is rotated such that the flat base element 12 moves in a linear manner, this will drive the rotation of the curved base element 14. The driving of the conveyor 18 may be effected by a motor (not shown) mechanically linked to one of the end sprockets 20, 22.

There are guide members (not shown) which direct a sheet of flexible material 26 between the corresponding formers 24 of the base elements 12, 14. An example of flexible material 26 used is fibrous material such as cardboard. The corresponding formers 24 serve to both fold the flexible material 26 so as to create creased corrugations at a non-elevated or room temperature and, as the base element 14 rotates, feed the material 26 between said formers 24 such that a plurality of identical corrugations 25 are formed adjacent one another along the length of the material 26 in a direction parallel to the direction of motion of the base element 12. The folding occurs predominately between the peaks 13 of corresponding adjacent formers 24: one of which is of the first base element 12 and the other of which is of the second base element 14. Each creased corrugation extends across the width of the material 26 in a direction parallel to that of the axis of rotation of the base element 14.

The process used by the corrugator 10 to create the corrugations 25 differs from that of conventional corrugators in that the corrugations 25 are formed in the material 26 by a plurality of discrete folds, as opposed to being pressed into the material in a hot atmosphere of steam at high pressure. Conventional corrugation forming using steam and elevated temperatures actually reconfigures the fibres of the material being corrugated, resulting in the material remaining continuously curved once cooled. In the present invention, cold pressing to form corrugations by discrete folds reduces the complexity of the corrugator and lessens both the financial and environmental cost of the process.

The lateral cross-section of the formers 24 is chosen so as to create corrugations of a particular profile. An example of the profile of corrugation 25 produced by the corrugator 10 is shown in FIG. 5. The folding technique creates creased corrugations 25 with straight sides 34. Corrugations created by the conventional pressing technique have curved sides and are not creased or folded, such that the profile is continuously arcuate and substantially sinusoidal.

A corrugated board 32 is manufactured by sandwiching the corrugated material 26 between two liner layers 28, 30. Corrugated board 32 which comprises sinusoidal corrugation corrugated material, such as that manufactured using the pressing method mentioned above, has less compressive or ‘crush’ strength in the direction parallel to the height of the corrugations 25 compared to that which comprises corrugations 25 with straight sides 34.

In the corrugated board 32 shown in FIG. 5, the corrugations 25 have a radiused apex portion 36 intermediate each straight or flat side 34. Using a different lateral cross-section of corrugation former 24 it is also possible to create corrugations 25 with a profile which comprises a straight portion (not shown) intermediate each straight side 34 instead of the radiused apex portion 36. This has the advantage that each corrugation 25 has a greater surface area which may provide a larger bonding surface for said liner layers 28, 30 and hence a stronger bond.

The folding process has the additional benefit that corrugations created in this manner can have sides 34 which subtend a much smaller angle 38 compared to those formed by the pressing method. In the case of FIG. 5, this angle is 61.1 degrees. The corrugator 10 may produce corrugations 25 with an angle 38 in the range of 60 to 64 degrees by using corrugation formers 24 of a different size and shape. The use of corrugations 25 with an angle in this range results in corrugated board with a greater crush strength compared to conventionally pressed corrugated board. This is due to there being both a′ greater concentration or number of corrugations 25 per unit length of board, preferably at least 5 corrugations per inch (25.4 mm) which heretofore has not been possible, and the flat sides 34 of the corrugations 25 being such that they lie in a direction, a greater component of which is perpendicular to the planes of the liner layers 28, 30. In particular, the at least 5 corrugations per inch (25.4 mm) are created in 3 mm thick B-flute caliper type board.

By decreasing the pitch of the corrugations 25 per unit length of corrugated material 26 results in corrugated board 32 having greater compressive strength in a direction of the longitudinal extent of each corrugation 25. In other words, the ‘spine strength’ of the corrugations, and thus also the corrugated material, is increased.

Once the material 26 has been corrugated it is held in place on the conveyor 18 by vacuum means. Such means may comprise a plurality of apertures (not shown) in a surface of each base plate 16, which are linked by an airtight conduit (also not shown) to a vacuum pump.

The conveyor 18 carries the corrugated material 26 to an adhesive apparatus (indicated generally as 40). The adhesive apparatus 40 comprises an adhesive tank 41 which contains the adhesive to be used. The apparatus also comprises a rotatable cylinder 42. The cylinder 42 is positioned and sized such that its axis of rotation is parallel to that of the base element 14 and such that it is adjacent to the conveyor 18, the conveyor 18 forming a tangential surface relative to the circumferential surface of the cylinder 42. There is a clearance (not shown) between the conveyor 18 and the circumferential surface of the cylinder 42 slightly greater than the thickness of the corrugated material 26, such that as the corrugated material 26 is carried by the conveyor 18 past the cylinder 42 it does not contact the cylinder 42.

A metering blade 44, which runs parallel to the axis of rotation of the cylinder 42 and extends along the cylinder's entire length, is positioned such that it abuts the circumferential surface of the cylinder 42. As seen best in FIG. 9, there are a plurality of similar channels 45 spaced along the length of the surface of the metering blade 44 which abuts the cylinder 42. The channels 45 run in a direction perpendicular to the axis of rotation of the cylinder 42 and act such that as the cylinder 42 is rotated in the direction indicated by arrow 46, adhesive 48 is drawn through the plurality of openings provided between the channels 45 and the circumferential surface of the cylinder 42. As the cylinder 42 rotates, this causes a plurality of separate or discrete circumferential ring-like portions of adhesive to form on the cylinder 42. Simultaneously, as the cylinder 42 rotates, the edge portions 48 of the metering blade 44 which abut the cylinder 42 remove any excess adhesive form the cylinder 42 surface.

The cylinder 42 rotates such that its circumferential surface travels at a speed similar or identical to the speed of the conveyor 18. The ring-like adhesive portions 48 protrude from the surface of the cylinder 42 such that as the corrugated material 26 passes the cylinder 42 on the conveyor 18, the radiused apex portions 36 of the of the ridges of the corrugations 25 closest the cylinder surface contact the adhesive 48 and as such a quantity of adhesive is transferred to the material. Due to a combination of the spacing of the ring-like adhesive portions 48 and the spacing of the corrugations 25, a plurality of row and columns of discrete spots 50 of adhesive are applied to the material 26 by the cylinder 42. The cylinder 42 continues rotating, replenishing the adhesive at the metering blade 44 and continuously applying it to the corrugated material 26 as described.

Conventional corrugators use a starch-based adhesive which is applied at high temperatures (in excess of 100 degrees Celsius) along the entire length of each corrugation 25. The proposed invention uses an adhesive which is applied at room temperature, typically in the range of 19 to 25 degrees Celsius, to discrete portions along the length of each corrugation 25. The combination of energy saved by not heating the adhesive and adhesive saved due to using discrete portions leads to a saving in both financial and environmental cost by the present invention.

Such an adhesive that can be used is polyvinyl acetate (also known as PVA) adhesive. It has been found that such an adhesive has a 4 second fibre tack time at room temperature.

A further advantage of the present invention is that conventional corrugators require a long conveyor to allow drying of the adhesive and as the corrugated board formed by the corrugator of the present invention does not require high temperatures to dry the adhesive, the conveyor 18 and hence the total size of the corrugator 10 can be more compact.

Subsequent to the application of adhesive 50, the conveyor 18 transports the corrugated material 26 to liner apparatus (not shown), which applies a sheet of liner material to the radiused apex portions of the corrugated material 26 having adhesive thereon. Traditionally, this process has always been carried out whereby the corrugated material and applied adhesive are retained on a first rotating curved surface, such as a drum, with the liner being fed to and applied to the corrugations at a tangent to the first curved surface by a second rotating curved surface, such as a roller, adjacent the first rotating curved surface. In the present invention, the corrugated material 26 and applied adhesive 50 is retained on a linear surface, which may be part of the conveyor 18 or part of another linear conveyor (not shown), and the liner is linearly fed by linear feeding means to the corrugations at an angle to the linear surface. Unlike with the traditional arrangement, where a combination of gravity and the rotation of the cylindrical retention surface can result in adhesive being expelled from the corrugated material, the retention surface of the present invention does not rotate and can be orientated such that gravity acts to maintain the adhesive on the corrugated material, loss of adhesive from the corrugated material is much less likely to occur. The adhesive application and liner process may then be repeated following the affixing of the first liner sheet so as to apply a second liner sheet to the other side of the corrugated material.

The embodiments described above are given by way of examples only and various other modifications will be apparent to persons skilled in the art without departing from the scope of the present invention as defined by the appended claims. For example, the flexible material could be a plastics material, a metal material, a composite material, or any other suitable flexible material. Although the flexible material, used either to form corrugations or as a liner, is typically a sheet, one or more strips could be corrugated or applied as a liner. The flexible material may by a single layer, or multiple layers.

As an alternative to the substantially isosceles triangle shape of the corrugations created in the flexible material, which comprise a radiused apex, the corrugation formers could be shaped so as to produce substantially isosceles trapezium shaped corrugations comprising a substantially flat plateau portion intermediate two straight or flat side portions at an acute angle to one another. This would enable the intermediate plateau portion to provide a large surface area for a liner to be attached.

It is also contemplated that the rotatable base element could be in the form of a conveyor, instead of a roller.

In the described embodiments the conveyor functions by the co-operation of chain and sprockets. However, alternate drive methods are envisaged such as belt and pulleys.

An alternative type of adhesive such as Ethylene Vinyl Acetate (EVA) or epoxy or acrylic based resins may be used.

Furthermore, instead of being external, the adhesive tank and adhesive metering means could be provided within the adhesive cylinder to feed adhesive to the exterior surface of the cylinder via, for example a plurality of groups of small apertures arranged in discrete rings around the cylinder.

Hence the present invention results in several improvements over the conventional corrugator.

First, forming the corrugations as a series of discrete folds, compared with pressing the corrugations at high temperatures, effects not only a greater concentration in corrugations per unit distance but also a reduction in financial costs and energy consumption. The greater concentration of corrugations gives rise to not only an increase in compressive strength in a direction parallel to the height of the corrugations, but also in an increase in compressive strength of the longitudinal extent of each corrugation.

Secondly, the use of discrete folds enables the creation of corrugations with a non-arcuate cross-section with radiused apex regions. The non-arcuate shape leads to an increase in compressive strength in a direction parallel to the height of the corrugations; and the radiused apex region allows greater bonding strength between each corrugation and an attached liner sheet. The non-arcuate shape incorporates flat regions which lie in a plane, a component of which is perpendicular to the plane of attached liners. This also effects an increase in compressive strength of corrugated board in a direction parallel to the height of the corrugations.

Thirdly, the room temperature adhesive process, wherein only discrete portions of adhesive are applied to each corrugation again results in a reduction in financial costs and wastage.

1-42. (canceled)

43. A corrugator comprising:
a curved base element rotatable around an axis of rotation,
a flat base element translatable relative to said axis of rotation,
said base elements having a plurality of corresponding corrugation formers such that a flexible material may be fed between said base elements, the corresponding corrugation formers interdigitating such that said flexible material is folded at a non-elevated temperature by the co-operation of the corrugation formers so as to create creased corrugations in the flexible material;
vacuum means for retaining said flexible material on the corrugation formers of the flat base element during the subsequent application of a liner material;
a rotatable adhesive cylinder downstream of the base elements;
an adhesive tank with supply means for supplying adhesive stored in the adhesive tank to an outer surface of said adhesive cylinder;
a feeder mechanism by which the corrugated sheet of flexible material is fed to said adhesive cylinder, the adhesive being transferred at a non-elevated temperature from said in use adhesive cylinder to a portion of each of the corrugations on to a side of said corrugated material;
the supply means comprising a metering element for metering adhesive on to the adhesive cylinder, said metering element comprising a metering blade adjacent to said adhesive cylinder, the metering blade having a plurality of channels for allowing the flow of adhesive to said adhesive cylinder wherein adhesive is fed to said adhesive cylinder such that a spot of adhesive
is applied to a plurality of discrete portions of each corrugation.

44. A corrugator as claimed in claim 43, wherein the lateral cross-section of at least one of said corrugation formers is generally V-shaped.

45. A corrugator as claimed in claim 43, wherein said corrugating formers are operable at room temperature to form corrugations in the flexible material.

46. A corrugator as claimed in claim 43, wherein the corrugating formers are positioned and shaped such that the profile of the corrugations created in said flexible material is a folded or creased splayed U-shape comprising a radius portion intermediate two straight portions at an acute angle to one another.

47. A corrugator as claimed in claim 46, wherein the corrugating formers are positioned and shaped such that the profile of the corrugations created in said flexible material is substantially an isosceles trapezium with its base removed comprising a folded or creased radiused apex portion intermediate two straight or flat side portions at an acute angle in the range of 60 to 64 degrees to another.

48. A corrugator as claimed in claim 43, further comprising liner means for affixing the liner material to each of the corrugations on a first side of said flexible material following corrugation, the liner means comprising liner feeding means for feeding the liner to the corrugated material and a linearly moving surface which retains the corrugated material as the liner is applied.

49. A corrugator as claimed in claim 43, wherein the adhesive is a room temperature bonding agent.

50. A caliper of corrugated material formed using the corrugator as claimed in claim 43, wherein the corrugated material is 3 mm thick, similar to a B-flute caliper-type cardboard, but having at least five corrugations per linear inch (25.4 millimetres).

51. A corrugator as claimed in claim 43, wherein the pitch of the at least one channel of the metering blade determines the volume of adhesive which is transferred from said adhesive cylinder to said portion of each of the corrugations.

52. A corrugator as claimed in claim 51, wherein the lateral dimension of at least one channel is devised so as to apply a particular discrete volume of adhesive to each corrugation.

53. A corrugator as claimed in claim 43, wherein the metering blade comprises an edge which removes excess adhesive from the adhesive cylinder.
